(19) United States
(12) Patent Application Publication
(10) Pub. No.: US 2013/0102212 A1
(43) Pub. Date: Apr. 25, 2013

(54) AXIALLY STABILIZING APPARATUS

(71) Applicants: PHILLIP RAINEY, San Diego, CA (US); Robert Rief, San Diego, CA (US)

(72) Inventors: PHILLIP RAINEY, San Diego, CA (US); Robert Rief, San Diego, CA (US)

(21) Appl. No.: 13/277,834

(22) Filed: Oct. 20, 2011

(51) Int. Cl. B63B 35/79; B23P 17/04; B63B 1/00

(52) U.S. Cl. 441/79; 29/527.1

(57) ABSTRACT

An axially stabilizing apparatus, adapted for stabilizing a water sport board along an axis of rotation is disclosed. The axially stabilizing apparatus generally comprises a port side stabilizing member, at least one port side affixing element for affixing the port side stabilizing member to the water sport board, a starboard side stabilizing member, at least one starboard side affixing element for affixing the starboard side stabilizing member to the water sport board.

### FIELD

The present disclosure relates to stabilizing a water sport board floatation device generally used as recreational equipment in a fluid medium.

### BACKGROUND

Stand Up Paddleboards (“SUPs”) are one type of water sport board comprising small water-going vessels that permit a user to navigate through various water bodies using a paddle or oar. SUPs evolved out of traditional paddleboards. With traditional paddleboards, the user would lie in the prone position and use their arms to paddle and propel the board. Traditional paddleboards were conceived to be larger and more buoyant than surf boards so that the user could cover longer distances with less effort. The increased size and buoyancy permitted a user to cover more distance in the water with each stroke of their arm. Paddleboards grew larger and buoyant enough that a user could stand upright, and propel the craft through the use of a paddle or oar. These became the Stand Up paddleboards, or SUPs. SUPs have been further adapted to serve diverse roles in myriad of applications. Users now use SUPs for surfing, exercise, cruising, short distance travel, and even as floating platforms for performing yoga exercises. More recently, SUP enthusiasts have sought to apply stand-up paddleboarding to flat-water applications, such as lakes and rivers.

When users began using SUPs to navigate whitewater rapids in rivers, traditional rigid SUPs made from fiberglass suffered severe damage as a result of collisions with rocks, or other obstacles. SUPs further evolved to an inflatable design for enhanced durability and flexibility for these applications. Inflatable SUPs are also more easily transported and stored in their deflated state.

Inflatable SUPs, however, have suffered form the deficiency of lacking rigidity and stability offered by traditional SUPs. Accordingly, inflatable SUPs have been characterized as much less stable and maneuverable than traditional SUPs. Users of inflatable SUPs often find themselves falling off of the board, which can increase the risk of injury when navigating surf in the ocean or whitewater rapids in rivers.

Therefore, the present disclosure provides a solution to increase stability and rigidity in literally all forms of water sport boards.

### SUMMARY

In one embodiment of the present teachings, an axially stabilizing apparatus, adapted for stabilizing a water sport board along an axis of rotation, is disclosed. The axially stabilizing apparatus generally comprises a port side stabilizing member, at least one port side affixing element, adapted for affixing the port side stabilizing member to the water sport board, a starboard side stabilizing member, and at least one starboard side affixing element, adapted for affixing the starboard side stabilizing member to the water sport board.

### BRIEF DESCRIPTION OF THE DRAWINGS

Embodiments of the present disclosure will be more readily understood by reference to the following figures, in which like reference numbers and designations indicate like elements.

FIG. 1a illustrates a top plan view of an axially stabilizing apparatus, according to one embodiment of the present teachings.

FIG. 1b illustrates a bottom plan view of the axially stabilizing apparatus, according to of one embodiment the present teachings.

FIG. 2a illustrates a top plan view of an axially stabilized water sport board, according to of one embodiment of the present teachings.

FIG. 2b illustrates a cross-sectional view of an axially stabilized water sport board, according to one embodiment of the present teachings.

FIG. 3 illustrates a method of manufacturing, according to one embodiment of the present teachings.

### DETAILED DESCRIPTION

The present disclosure relates to water sport boards used primarily for recreational purposes. Although the present teachings are described within the context of one variety of water sport board, the scope of the disclosure is intended to encompass and be adaptable for literally any variety of water sport board.

Overview

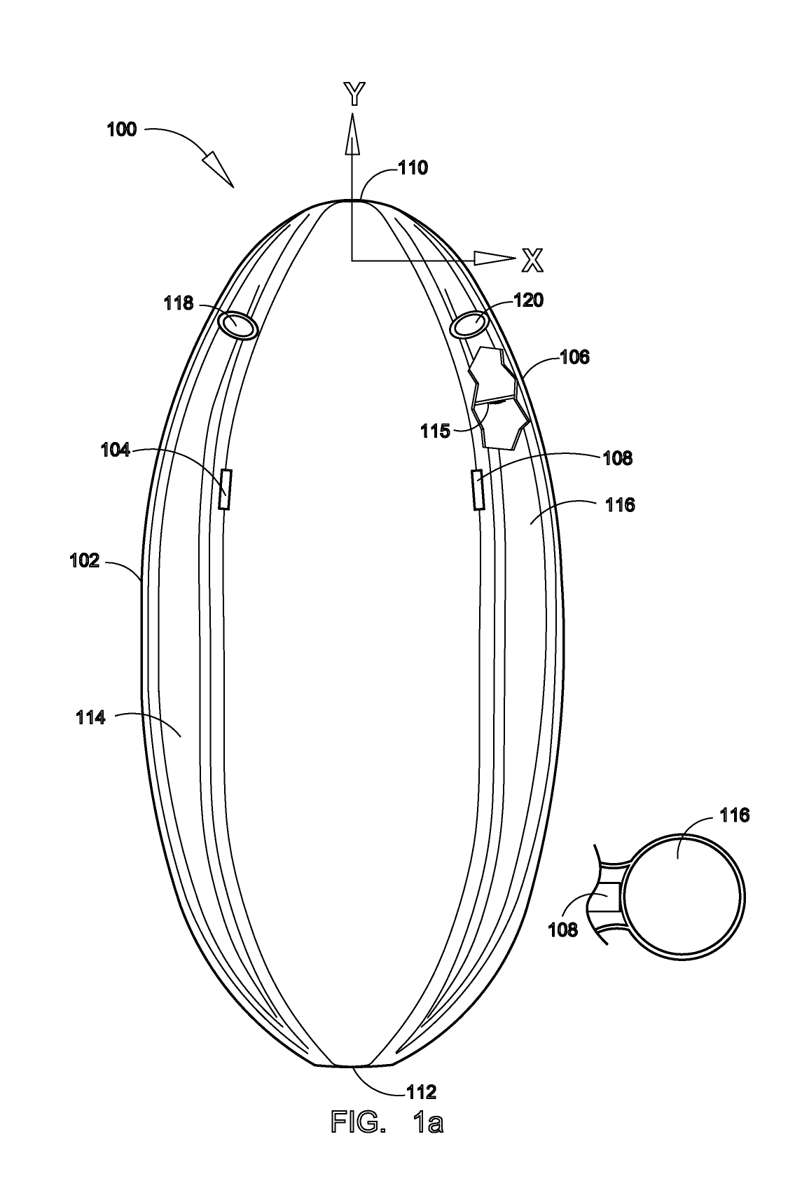

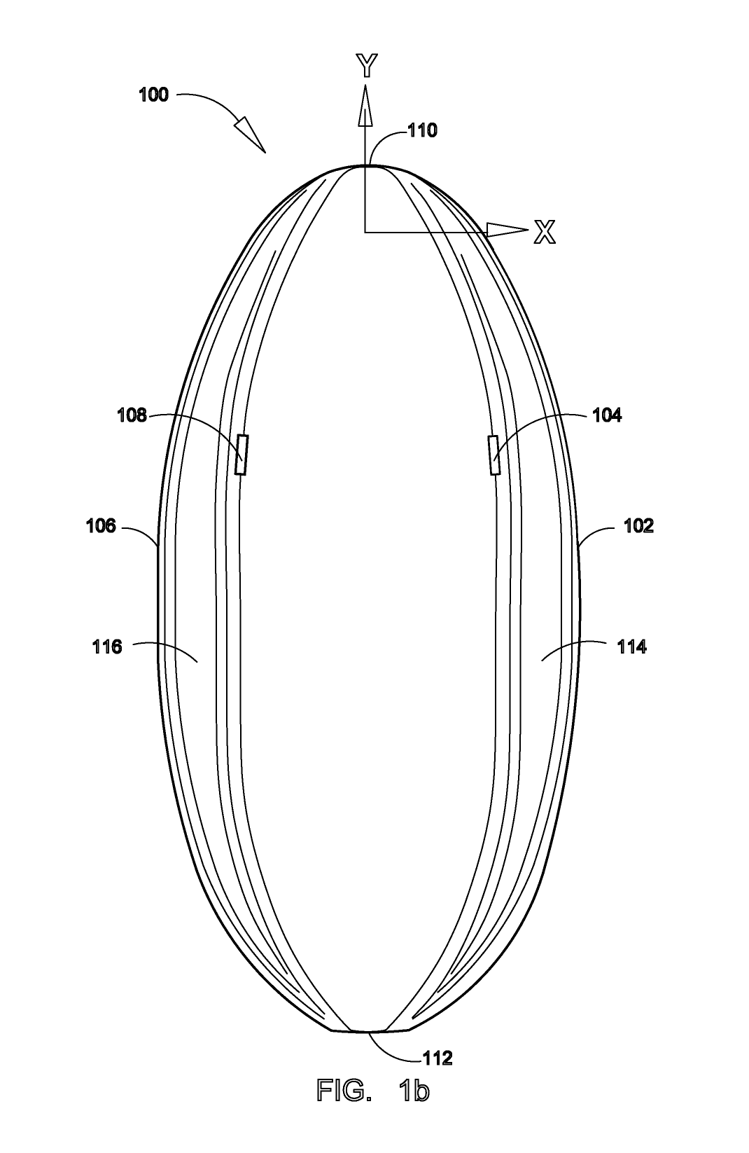

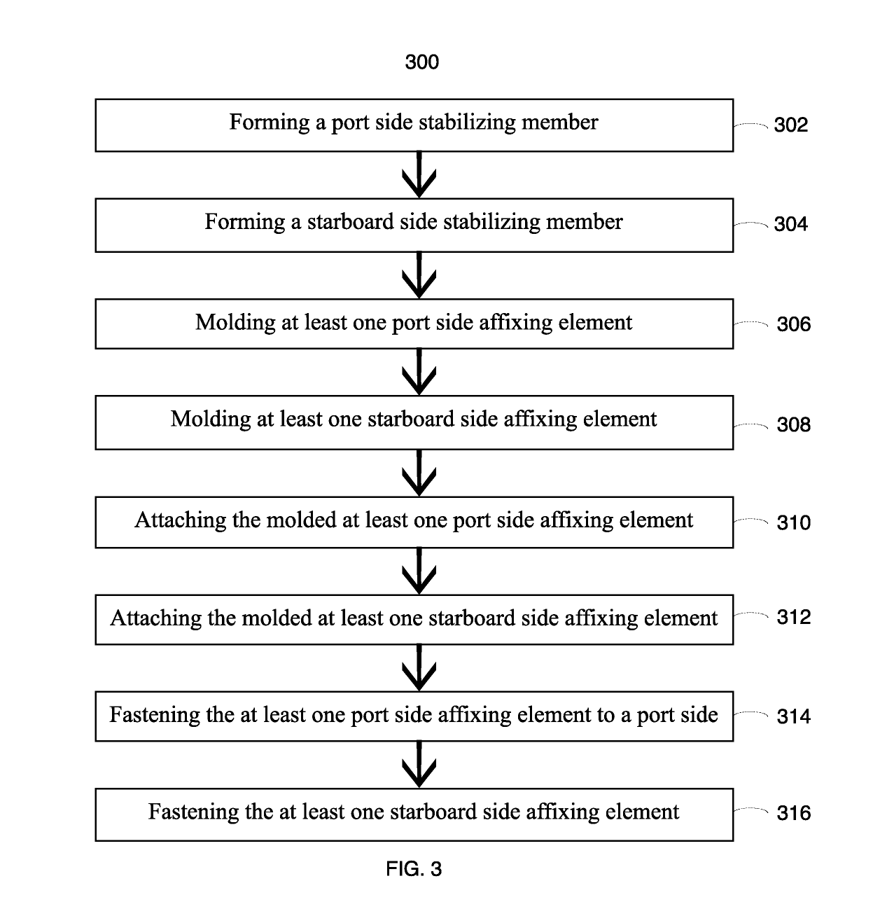

Referring generally to FIGS. 1-3, the present teachings describe an axially stabilizing apparatus 100 and axially stabilized water sport board 200 adapted for use with a variety of water sport boards. In some embodiments, the apparatus is adapted for use in a stand-up paddleboard (“SUP”). The word “SUPs” refer to the same in a plural form. “SUPing” refers to the activity employing a SUP, or stand-up paddle boarding. Although some embodiments described herein relate specifically to an inflatable SUP, the scope of the present disclosure is not limited to inflatable SUPs. Some embodiments disclosed herein relate to use of the axially stabilizing apparatus with literally any kind of water sport board.

Generally speaking, SUP safety and stability challenges are different than traditional water sport boards. This is partly due to a longer moment arm created by the fact that an SUP user is standing perpendicular to the plane of the SUP, whereas, by contrast a traditional water sport board user lays parallel along a surface of the water sport board, thereby having a shorter moment arm. Due to the longer moment arm, significantly less torque is required to destabilize an SUP than that required to destabilize traditional water sport boards. This is a significant safety concern because the ability of the SUP to remain parallel to the plane of the water surface is reduced due to a longer moment arm created along the user's body. In some applications, an SUP is used in areas that are dangerous, such as white water rapids in a river. In these applications, stability of the SUP is important for the safety of the user. More specifically, longitudinal axial stability and lateral axial stability contribute to an SUP user's safety to prevent injury. The present disclosure provides a solution to the problem of a water sport board rotating about either a longitudinal axis and/or a lateral axis by providing a restoring force in an opposite direction of applied torque.

In one illustrative exemplary embodiment, the present teachings provide advantageous versions of inflatable devices for stand-up paddle boarding activities, or SUPs. The present teachings enhance the rigidity and stability of conventional inflatable SUPs. This enhanced rigidity and stability provides additional safety and maneuverability to the user. Because a SUP enthusiast is usually standing when using the board, the user's center of gravity is much higher off the plane of the water surface as compared to a seated user of a water sport board, wherein a typical user is lying face-down and paddling. Moreover, because SUP users focus most of their weight along a smaller surface area of the craft (as compared with a water sport board wherein the user lays parallel to the board), conventional inflatables tend to deflect and deform under use. These deflections and deformations prohibit the SUP from behaving like traditional fiberglass paddleboards. Therefore, inflatable SUP users cannot exhibit the control or maneuverability over their inflatable SUPs they could otherwise exhibit over traditional rigid SUPs. This lack of maneuverability and control increases the risk a SUP user will fall off the SUP and cause injury.

Axially Stabilizing Apparatus

Referring now to FIGS. 1a-1b, in one embodiment, an axially stabilizing apparatus 100, adapted for stabilizing a water sport board along an axis of rotation, is disclosed. FIGS. 1a-1b illustrates the axially stabilizing apparatus 100 without a water sport board. The axially stabilizing apparatus generally comprises a port side stabilizing member 102, at least one port side affixing element 104, a starboard side stabilizing member 106, and at least one starboard side affixing element 108. The present disclosure defines two axes of rotation for illustrative purposes. A longitudinal axis defined from a water sport board fore 110 to a water sport board aft 112, along a y-axis as illustrated in FIGS. 1a-1b defines a longitudinal axis of rotation. If a user of a water sport board distributes his/her weight asymmetrically, with respect to the longitudinal axis of rotation, the user is in danger of falling off the water sport board. Similarly, even if the user proportionately distributes his/her weight, with respect to the longitudinal axis of rotation, if a force is applied from a source other than from the user, such as for example disproportionate water flow in a river rapid, such force can cause the water sport board to rotate about the longitudinal axis of rotation, thereby causing the user to lose balance and fall, potentially causing injury. The axially stabilizing apparatus 100 functions to provide an opposing force to prevent rotation about the longitudinal axis of rotation, this will be referred to herein as laterally stability. This restoring force is provided via the buoyancy of the axially stabilizing apparatus 100.

Port Side

The axially stabilizing apparatus 100 comprises the port side stabilizing member 102 having a port side stabilizing floatation element 114. In one embodiment, the port side stabilizing floatation element 114 comprises inflatable rubber tubing, aligned substantially parallel to the longitudinal axis of the water sport board. The port side stabilizing floatation element 114 is disposed laterally adjacent the water sport board on the port side. In one alternate embodiment, the port side stabilizing floatation element 114 further comprises multiple chambers. In these embodiments, such multiple chambers further provide a measure of additional safety, because if one chamber deflates, the other chambers will continue to provide at least some stabilizing force to support the user, such that the user may still reach safety.

Embodiments wherein the port side stabilizing floatation element 114 comprises an inflatable tubing having multiple chambers disposed therein, the port side stabilizing floatation element 114 further comprises a port inflation receptacle 118, adapted for use to inflate a chamber in the port side stabilizing flotation element 114. In this multi-chamber embodiment, a separator element divides each chamber and is disposed interior to the port side stabilizing floatation element 114. That is, as a mechanical dividing boundary between chambers, the separator element mechanically partitions and seals each chamber to prevent air flow between chambers. Each chamber is adapted to have individual inflation receptacles for inflation. Therefore, in the event of one chamber deflating, the other chambers maintain proper inflation due to the separator element.

Although the illustrative exemplary embodiments of the at least one port side stabilizing floatation element 114 have been described in terms of an inflatable rubber tubing, other materials, both inflatable and non-inflatable, such as for example wood, cork, plastic, or other natural or man-made buoyant materials may be used without departing from the scope of the present teachings. In one alternate embodiment foam material may optionally be used.

The port side stabilizing floatation element 114 is attached to a water sport board with at least one port side affixing element 104. The at least one port side affixing element 104 may be composed of rubber, plastic, metal, or wood. In one embodiment, the at least one port side affixing element 104 is attached to the water sport board with a chemical weld for a permanent attachment. Alternate embodiments include attaching the at least one port side affixing element 104 to the water sport board with a mechanical process, such as for example heating, riveting, or snap-fit. Furthermore, the at least one port side affixing element 104 may optionally comprise a strap, such as for example a webbing strap, adapted to affix the at least one port side affixing element 104 to the water sport board. Other embodiments within the scope of the present teachings include a sheath adapted to encapsulate the water sport board and the at least one port side affixing element 104.

In some embodiments the at least one port side affixing element 104 comprises Velcro®, magnetic affixing elements, latching means, or literally any other form for affixing the port side stabilizing floatation element 114 to be removable by a user. In these embodiments, a user may affix various embodiments of port side stabilizing floatation elements 114, for example of different size, shape or configuration without departing from the scope and spirit of the present disclosure.

In addition to performing the function of attaching the port side stabilizing floatation element 114 to a water sport board, the at least one port side affixing element 104 further functions to provide longitudinal rigidity when attached to the water sport board. Without the port side affixing element 104, the port side stabilizing floatation element 114 has additional degrees of freedom to move independent of the water sport board, which is undesirable. That is, the at least one port side affixing element 104 also functions to keep the port side stabilizing floatation element 114 in a same horizontal plane as the water sport board. Therefore, the at least one port side affixing element 104 functions to keep the port side stabilizing floatation element 114 horizontally coplanar with the water sport board, thereby advantageously creating greater longitudinal stability.

Starboard Side

The axially stabilizing apparatus 100 comprises the starboard side stabilizing member 106 having a starboard side stabilizing floatation element 116. In one embodiment, the starboard side stabilizing floatation element 116 comprises inflatable rubber tubing, aligned substantially parallel to the longitudinal axis of the water sport board. The starboard side stabilizing floatation element 116 is disposed laterally adjacent the water sport board on a starboard side. In one alternate embodiment, the starboard side stabilizing floatation element 116 further comprises multiple chambers. In these embodiments, such multiple chambers further provides a measure of additional safety, because if one chamber deflates, the other chambers will continue to provide at least some stabilizing force to support the user, such that the user may still reach safety.

Embodiments wherein the starboard side stabilizing floatation element 116 comprises an inflatable tubing having multiple chambers disposed therein, the starboard side stabilizing floatation element 116 further comprises a starboard inflation receptacle 120, adapted for use to inflate the starboard side stabilizing flotation element 116. In this multi-chamber embodiment, a separator element 115 divides each chamber and is disposed interior to the starboard side stabilizing floatation element 116. That is, as a mechanical dividing boundary between chambers, the separator element 115 mechanically partitions and seals each chamber to prevent air flow between chambers. Each chamber is adapted to have individual inflation receptacles for inflation. Therefore, in the event of one chamber deflating, the other chambers maintain proper inflation due to the separator element 115.

Although the illustrative exemplary embodiments of the at least one starboard side stabilizing floatation element 116 have been described in terms of an inflatable rubber tubing, other materials, both inflatable and non-inflatable, such as for example wood, cork, plastic, or other natural or man-made buoyant materials may be used without departing from the scope of the present teachings.

The starboard side stabilizing floatation element 116 is attached to a water sport board with at least one starboard side affixing element 108. The at least one starboard side affixing element 108 may be composed of rubber, plastic, metal, or wood. In one embodiment, the at least one starboard side affixing element 108 is attached to the water sport board with a chemical weld for a permanent attachment. Alternate embodiments include attaching the at least one starboard side affixing element 108 to the water sport board with a mechanical process, such as for example heating, riveting, or snap-fit. Furthermore, the at least one starboard side affixing element 108 may optionally comprise a strap, such as for example a webbing strap, adapted to affix the at least one starboard side affixing element 108 to the water sport board. Other embodiments within the scope of the present teachings include a sheath adapted to encapsulate the water sport board and the at least one starboard side affixing element 108.

In some embodiments the at least one starboard side affixing element 108 comprises Velcro®, magnetic affixing elements, latching means, or literally any other form for affixing the starboard side stabilizing floatation element 116 to be removable by a user. In these embodiments, a user may affix various embodiments of starboard side stabilizing floatation elements 116, for example of different size, shape or configuration.

In addition to performing the function of attaching the starboard side stabilizing floatation element 116 to a water sport board, the at least one starboard side affixing element 106 further functions to provide longitudinal rigidity when attached to the water sport board. Without the starboard side affixing element 108, the starboard side stabilizing floatation element 116 has additional degrees of freedom to move independent of the water sport board, which is undesirable. That is, the at least one starboard side affixing element 108 also functions to keep the starboard side stabilizing floatation element 116 in a same horizontal plane as the water sport board. Therefore, the at least one starboard side affixing element 108 functions to keep the starboard side stabilizing floatation element 116 horizontally coplanar with the water sport board, thereby creating greater longitudinal stability.

Axially Stabilized Water Sport Board

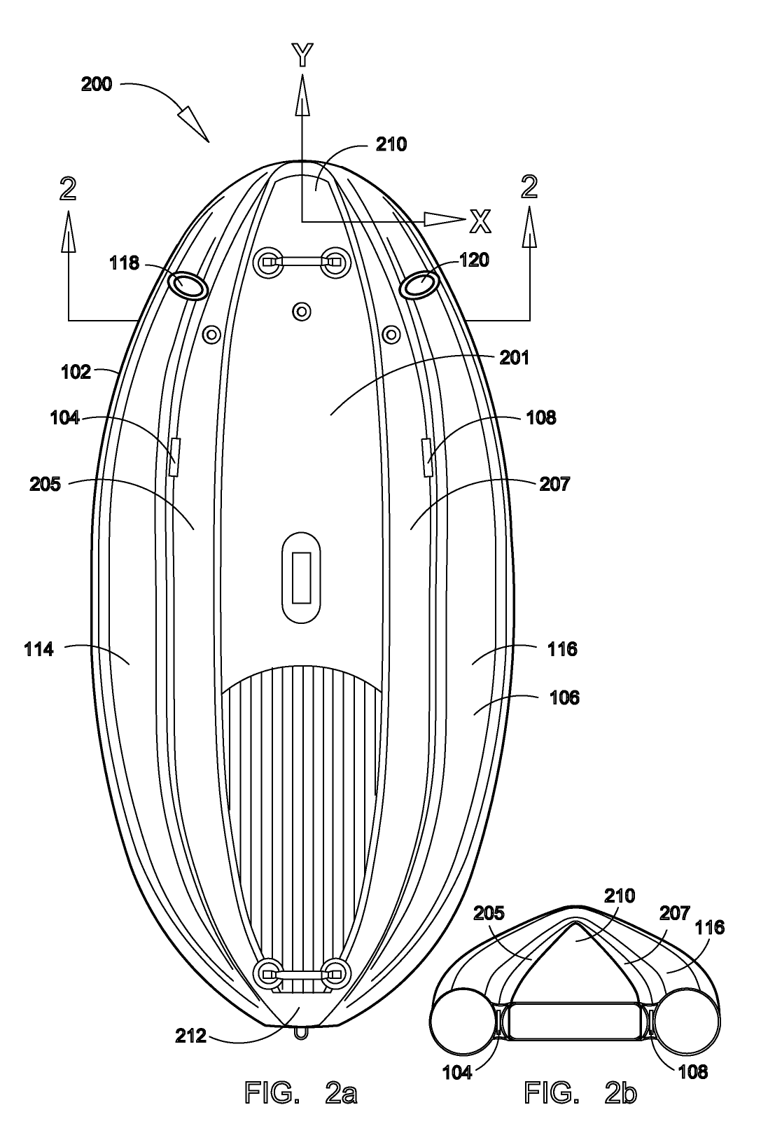

Referring now to FIGS. 2a and 2b in one embodiment, an axially stabilized water sport board 200 is disclosed. The axially stabilized water sport board 200 comprises the elements described above, with respect to the axially stabilizing apparatus 100, but also includes a main body water sport board member 201 disposed on an interior of the axially stabilizing apparatus 100. The main body water sport board member 201 generally comprises an elongate member, adapted to float on a fluid medium, having an aft end 212 and a fore end 210, defining a longitudinal axis. The main body water sport board member 201 further comprises a port side 205 and a starboard side 207, defining a lateral axis. As described above with respect to the axially stabilizing apparatus 100, the axially stabilized water sport board 200 functions to provide a restoring force when a user asymmetrically distributes his/her weight on the upper surface of the axially stabilized water sport board 200. This restoring force is provided via the buoyancy of the axially stabilizing apparatus 100. Furthermore, when a displacing force is applied from a lower surface of the water sport board 200, such as for example in a river having rapids, the axially stabilized water sport board 200 functions to remain stable with respect to both a longitudinal axis of rotation and a lateral axis of rotation via an opposing buoyancy force of the axially stabilizing apparatus 100. This function is achieved consistent with the above description of the axially stabilizing apparatus 100.

Some SUP enthusiasts require fully-inflatable solutions for flat-water applications like lakes and rivers, because inflatable SUPs are much less susceptible to damage as a result of underwater obstacles such as rocks. Moreover, flat-water SUP enthusiasts claim the inflatable design as advantageous over the rigid design because the inflatable vessel can be deflated, folded, or otherwise packed in a small form factor ideal for travel and storage purposes.

Despite the utilitarian advantages of the inflatable SUP design, enthusiasts maintain a desire for improved characteristics of maneuverability, control, and safety more commonly found on traditional rigid SUPs. In one embodiment, the present disclosure has described a fully-inflatable SUP design with described structures for improved stability and rigidity, conferring the improved control, maneuverability and safety sought by inflatable SUP enthusiasts.

In one embodiment an axially stabilized water sport board comprises a main body water sport board member inflatable section having exterior walls connected to each other through interior threading; and a plurality of tubular inflatable flanking sections spanning the longitudinal length of the craft that are tangentially affixed to the vertical sides of the main inflatable section. An SUP having only a single main-inflatable section may suffer from deflection and deformation under the point load of an enthusiast's use, the multi-chamber inflatable SUP disclosed herein does not deflect or deform as severely as a single-chamber inflatable SUP. This is because the inflatable tubular flanking sections provide enhanced rigidity along the sides of the main inflatable section.

In addition to preventing deflection and deformation from fore to aft (i.e. nose to tail), the new structure disclosed will enhance lateral stability from side to side. When a user stands upright on the craft, they may have to shift their weight from one side rail of the craft to another. With traditional inflatable SUPs, these shifts in weight may cause the vessel to tip, and thereby cause the user to lose balance, fall off, potentially causing injury. However, because the inflatable tubular flanking sections are disposed on each side rail of the water sport board, buoyant force from the inflatable tubular flanking sections counters the lateral force placed on the craft by the user's shift of weight from side to side. This counter-force is accomplished by the fact that the tangential affixing of the tubular flanks to the main inflatable section permits the tubular flanks to roll up and down for a limited degree, along the side rails of the craft.

According to several embodiments, the present disclosure will provide enhanced rigidity and stability in an inflatable SUP. Users of the apparatuses disclosed herein, and its methods for providing such advantages will be able to more easily maneuver and control the inflatable SUP. Increased maneuverability and control will result in increased performance, enjoyment, and safety for the user.

Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. An axially stabilized water sport board, comprising:
a.) a main body water sport board member, comprising:
an elongate member, adapted to float on fluid medium, having an aft end and a fore end forming a longitudinal axis, a port side and a starboard side forming a lateral axis;
b.) a port side stabilizing member, comprising:
a port side stabilizing floatation element, aligned along the longitudinal axis, disposed laterally adjacent the axially stabilized water sport board, configured in a substantially parallel orientation along the longitudinal axis;
c.) at least one port side affixing element, adapted for affixing the port side stabilizing member to the main body water sport board member;
d.) a starboard side stabilizing member, comprising:
a starboard side stabilizing floatation element, aligned along the longitudinal axis, disposed laterally adjacent the axially stabilized water sport board, configured in a substantially parallel orientation along the longitudinal axis, and;
d.) at least one starboard side affixing element, adapted for affixing the starboard side stabilizing member to the main body water sport board member.

2. The axially stabilized water sport board of claim 1, wherein the main body water sport board member comprises an inflatable water sport board.

3. The axially stabilized water sport board of claim 2, wherein the port side stabilizing member and the starboard side stabilizing member are inflatable.

4. The axially stabilized water sport board of claim 2, wherein the port side stabilizing member comprises at least one cylindrical air chamber.

5. The axially stabilized water sport board of claim 2, wherein the starboard side stabilizing member comprises at least one cylindrical air chamber.

6. An axially stabilizing apparatus, adapted for stabilizing a water sport board along an axis of rotation, comprising:
a.) a port side stabilizing member, comprising:
a port side stabilizing floatation element, aligned along a longitudinal axis of the water sport board, disposed laterally adjacent the water sport board, configured in a substantially parallel orientation along the longitudinal axis;
b.) at least one port side affixing element, adapted for affixing the port side stabilizing member to the water sport board;
c.) a starboard side stabilizing member, comprising:
a starboard side stabilizing floatation element, aligned along the longitudinal axis of the water sport board, disposed laterally adjacent the water sport board, configured in a substantially parallel orientation along the longitudinal axis;
d.) at least one starboard side affixing element, adapted for affixing the starboard side stabilizing member to the water sport board.

7. The axially stabilizing apparatus of claim 6, wherein the water sport board comprises an inflatable water sport board.

8. The axially stabilizing apparatus claim 7, wherein the port side stabilizing member and the starboard side stabilizing member are inflatable.

9. The axially stabilizing apparatus of claim 8, wherein the port side stabilizing member comprises at least one cylindrical air chamber.

10. The axially stabilizing water sport board of claim 9, wherein the starboard side stabilizing member comprises at least one cylindrical air chamber.

11. A means for stabilizing a water sport board along at least one axis of rotation, adapted for stabilizing the water sport board in a fluid medium, comprising:
a.) longitudinal stabilizing means for secondary stability along a longitudinal axis of the water sport board;
b.) lateral stabilizing means for secondary stability along a lateral axis of the water sport board, wherein the longitudinal axis and the lateral axis of the water sport board define a water sport board plane of rotation having an angle of rotation controlled by the longitudinal stabilizing means and the lateral stabilizing means.

12. A method of manufacturing an axially stabilized water sport board, comprising:
a.) a step of forming a port side stabilizing member;
b.) a step of forming a starboard side stabilizing member;
c.) a step of molding at least one port side affixing element;
d.) a step of molding at least one starboard side affixing element;
e.) a step of attaching the molded at least one port side affixing element to the formed port side stabilizing member;
f.) a step of attaching the molded at least one starboard side affixing element to the formed starboard side stabilizing member;
g.) a step of fastening the at least one port side affixing element to a port side of the axially stabilized water sport board;
h.) a step of fastening the at least one starboard side affixing element to a starboard side of the axially stabilized water sport board.
